(19) United States
(12) Patent Application Publication
(10) Pub. No.: US 2007/0068939 A1
(43) Pub. Date: Mar. 29, 2007

(54) Apparatus and Method for Microwave Heating Using Metallic Conveyor Belt

(75) Inventor: GEORGE M. HARRIS, LEWISTON, ME (US)

Correspondence Address: DYKAS, SHAVER & NIPPER, LLP, P.O. BOX 877, BOISE, ID, 83701-0877, US

(73) Assignee: The Ferrite Company, Inc., Mashua, NH (US)

(21) Appl. No.: 11/534,982

(22) Filed: Sep. 25, 2006

Related U.S. Application Data
(60) Provisional application No. 60/720,225, filed on Sep. 23, 2005.
(60) Provisional application No. 60/720,255, filed on Sep. 23, 2005.

(51) Int. Cl. H05B 6/72

(52) U.S. Cl. 219/761

(57) ABSTRACT

An apparatus, system, and method, for using circular mode magnetic microwave energy to heat the product in a continuous microwave process. The microwaves are generated and transmitted as rectangular waveguide mode microwave energy, and are converted by mode converters to circular magnetic mode microwave energy. As circular magnetic mode microwave energy, the microwave energy passes through a material and is reflected on the other side back into the material, thus traveling through the material a second time. Reflected microwave energy from the main reflected wave as well as reflections from other structures, surfaces and layers in the system travel back toward the microwave source. They are sensed, and a computer tuning system causes capacitive probes to generate offsetting microwave reflections, which are opposite in phase and equal in magnitude to the sum of all of the reflected waves. These induced reflections cancel and negate the reflected microwaves, resulting in optimum utilization of microwave energy to heat the product.

### CROSS-REFERENCE TO RELATED APPLICATIONS

This application claims the priority date of the provisional application entitled APPARATUS AND METHOD FOR USE OF METALLIC CONVEYOR BELTS FOR HIGH POWER MICROWAVE PROCESSING filed by George M. Harris on Sep. 23, 2006, with application Ser. No. 60/720,225.

### FIELD OF THE INVENTION

The present invention generally relates to microwave heating devices, and more particularly to microwave heating devices including a metallic conveyor belt for moving product through a microwave field.

### BACKGROUND OF THE INVENTION

High Power Microwaves are used all over the world for a large variety of applications including cooking, tempering, heating, defrosting, coagulation, rendering and boosting, as well as many other applications where microwave processing is applicable. Microwaves can be applied to items requiring processing in a variety of ways. Some include batch applications where the articles to be processed are loaded into the interior of a microwave system or cavity, the door is closed and the microwaves are applied. Usually, these high power microwaves are applied to the articles to be processed inside of the microwave system through transmission structures, such as waveguides or other types of transmission lines or structures. The high power microwaves are generated using a microwave transmitter or generator. The waves are carried from the microwave generator, or generators through these transmission lines or waveguides to the applicator or oven, where inside the cavity, the microwave electric and magnetic fields interact with the process materials and heat, temper, defrost, cook, boost or otherwise process it.

Depending on the physical size of the interior of the microwave system's cavity, the specific microwave properties of the items being processed and the frequency, (and hence, the wavelength), of the microwaves, the electric and magnetic fields will arrange themselves in variety of configurations, depending on these factors. If the wavelength of the microwaves is short compared to the physical dimensions of the inside of the microwave cavity, (as is usually the case with most current multi-mode industrial microwave systems), there are several possible configurations that the microwave electric and magnetic fields can assume. The larger the physical size of the interior of the microwave processing system is as compared to the wavelength of the microwaves, the greater the number of possible field configurations. These electric and magnetic field configurations are called “Modes”. Microwave electric and magnetic fields are “vector” quantities, meaning that they have two properties that define them. One of these properties is the magnitude, or intensity of the fields, and the other is the direction, meaning that they point in a specific direction inside of the microwave cavity. As stated above, if the inside dimensions of the cavity are large compared to the wavelength of the microwaves, there are usually several modes or field configurations that will form up inside of the microwave cavity. These many different modes will have electric and magnetic field vectors associated with them that exist at many different strengths and point in many different directions within the cavity's volume. In addition, most microwave ovens or processing systems of this kind contain devices that move either the articles being processed, and/or move the microwave application point within the microwave cavity. The reason for this is to ensure that, over the processing time, there will be a higher degree of probability that the items in the cavity that need to be processed with “run into” some of the microwave heating electric fields in the cavity's interior, and be processed. This “multi-mode” microwave system approach is quite popular and has been widely used in large industrial microwave systems for many decades.

Many large industrial microwave systems are designed so that the items being processed can be continually conveyed through the microwave system. This type of system usually utilizes a conveyor belt that operates continuously, and will carry the items to be processed through the system. These multi-mode type microwave processing systems contain microwave heating fields that are, again, oriented in many different directions and are at many different intensities. The conveyor belts on these systems must be capable of transporting the items to be processed through the interior volume of the cavity, usually near the center, and must be nearly transparent to the microwaves. Since microwaves that are used in industrial systems cannot penetrate materials that conduct electricity such as metal, the belts used in these systems must be made of microwave-transparent material, such as plastic or rubber, so that the heating fields are able to impinge on the items being processed, from all directions inside of the cavity, increasing the probability that the items being processed will “run into” enough heating fields to be properly processed.

In any high power microwave system, especially in cases where the items being heated or otherwise processed are food items that contain water, salt, fat or other substances, the electric field intensities in some regions of the interior of the cavity can be high enough so that an electric arc or plasma develops. The presence of the aforementioned substances from food items on the belt inside the cavity will usually greatly increase the propensity for sparks and arcs to develop because of the heating or burning of these substances in the microwave fields. In a situation like this, the temperature of the arc or plasma is high enough to melt then burn the plastic or rubber belt material. Once the belt material begins to burn, the combustion products from this burning material change chemically and become able to absorb large amounts of energy from the microwave heating fields in the cavity. Instead of the conveyor belt being transparent to the microwave heating fields, the belt absorbs the microwave power and becomes extremely hot, burning further. This subsequent burning creates more microwave-absorbent combustion products, which, in tern, will cause even more burning. This is a catastrophic “run-away” situation. The combustion fumes can be toxic, and can also contaminate a large portion of the microwave system. After an event such as this, the entire microwave processing cavity usually needs to be completely cleaned, and the expensive conveyor belt replaced. This is a very expensive process, resulting in down-time as well as the direct costs of system repair.

As a consequence, the use of metal belts in these types of microwave ovens has been tried. The results, however, have not been favorable, since the very presence of the metal belt inside the cavity completely changes the multi-mode heating field configuration. In most cases, it is the microwave electric field that imparts most of the heating power to food items being processed. In traditional multi-mode microwave processing systems, a metal belt imposes certain field boundary conditions on the microwave field configurations that severely limit the effectiveness, results and flexibility of this type of system using a metal conveyor belt. In addition, the presence of the metal belt in a traditional multi-mode microwave cavity can severely distort the electric and magnetic fields, causing “hot spots” and “cold spots” on, and within the products being processed.

### SUMMARY OF THE INVENTION

This invention makes the use an arrayed, single-mode microwave application system that makes the use of metal belts in a conveyorized industrial microwave processing systems possible. In the invention described in this document, a burn-resistant high temperature metal conveyor belt forms a microwave-reflecting image plane, directly below the items being processed, which is a very important and a required part of the system. The metal belt used can be made of stainless steel, metal mesh, metal screening or anything similar. The microwaves are applied through several application points, carefully positioned over the moving metal conveyor belt image plane. The applicators launch a microwave mode that has its electric field vectors pointing from the applicator plane directly at the image plane formed by the metal belt. In this case, the propagation mode in the “L-Band” and “S-Band” microwave systems is Transverse Magnetic 01, or in common notation TM₀₁. The exact location and position of these arrayed single-mode applicators can be adjusted for the type of heating and/or processing desired, so that the heating and/or processing of the items in the microwave system is very even and symmetrical. Also, since the electric and magnetic field vectors are quite well defined, it is possible to configure the system so that microwave heating can be specifically controlled in real-time, under power, during the process. Since the entire microwave system enclosure does not actually form the boundary system for several different standing-wave microwave resonant modes, as is the case with most traditional multi-mode microwave systems, the application system is referred to by this inventor as a processing “cell” and not a cavity.

In this invention, the adaptation establishes the arrayed applicators so that they project or launch the microwaves in a very specific electric and magnetic field configuration. The TM₀₁ Mode electric field vectors, (or E Vectors), from the applicators encounter the metal conveyor belt at a nearly 90 degree angle with the plane of the belt. Since these E Vectors are nearly perpendicular to the image plane formed by the metal conveyor belt surface, the E vectors impinge directly on the items being processed on the belt. The electric fields in this orientation pass from the top, through the items being processed. The fields that remain after passing through the items being processed then encounter the belt image plane and are reflected back toward the applicator, again passing up through the items being processed, a second time. In many cases, electric fields that are oriented or “columnated” in this manner are very desirable for the benefit of the process. Since the image plane established by the metal belt will reduce or extinguish electric field vectors that are oriented in directions that are parallel or tangent to the image plane, the metal belt reduces or even eliminates undesirable effects of high strength microwave E Vectors that “point” across the image plane of the belt from one item in the cell to the other. This reduces or eliminates the burning together of some items in the system that are positioned next to each other, such as meatballs that are being boost-heated or chicken wings. In addition, the metal belt is highly resistant to the high temperature effects of other processing requirements such as frying in deep fat, or cooking in impingement ovens in conjunction with the microwave system.

This is a highly desirable result for many food items such as meatballs, chicken wings and other products.

Another aspect of the invention is a system for heating product through the use of microwave energy which passes through a product, and is reflected back into the product by a metallic conveyer belt which passes through the system, and on which the product is supported and transported. The reflected wave is sensed, and tuned to cancel the reflected microwave energy for maximum efficiency. The product would typically be arranged as a mass of products on a conveyor belt, which passes through the microwave heating cell or chamber of the invention. The product is illuminated with a traveling wave of microwave energy which is absorbed by the product as the microwave energy passes through the product. The microwave energy is then reflected back into the product by the metallic conveyer belt, where more energy is absorbed as it passes all the way through the product again, and the remaining microwave energy is sensed upon exiting the product. The reflected energy from the incident wave and all other reflections from the product are combined, and the combined reflected energy is measured by sensors. Tuners are used to generate an induced reflection which cancels the reflected energy.

This system includes one or more microwave sources for illuminating and heating the product before it exits the processing cell. It also includes one or more wave guide networks for guiding a microwave traveling wave from the microwave source to the product. The system also includes one or more mode converters which convert rectangular wave guide mode to circular magnetic mode microwave energy. The system also includes one or more circular magnetic mode microwave applicators. The system also includes a metallic conveyor belt which acts as a microwave reflecting surface which is located below the product from the point of entry of the microwaves into the product. The reflecting surface of the metallic conveyer belt reflects the microwave traveling wave which exits an opposite side of the product, and redirects it directly back into the product.

The system also includes one or more sensors of microwave energy for measuring the microwave energy which is passed through the product after being reflected, as well as other reflected microwave energy. These sensors of microwave energy report the energy measured to a computer tuning system. The system also includes a computer tuning system which uses the reported microwave energy which is measured by the sensors of microwave energy, to calculate adjustments required to reduce the amount of reflected microwaves passing back toward the microwave source to approximately zero. The system also includes a means of tuning the microwaves based on a signal from the computer tuning system.

This system can be designed so that the means for tuning the microwave generated is one or more capacitive probes which are activated by a signal from the computer tuning system and which allow the computer tuning system to control the phase of the applied microwave. The capacitive probes induce reflections which are opposite in phase and equal in magnitude to the reflected microwave energy. The system can utilize microwave reflecting structures to compensate for microwave reflections by other parts of the system.

In accordance with another aspect of the invention, the invention is an apparatus for generating heat in products, while using a metallic conveyor belt. The product, as in the previous embodiment, is typically composed of individual pieces of food material which are grouped together on a moving conveyor belt which takes the product through the processing cell of the device. Heat is generated in the product by illuminating the product with a traveling wave of microwave energy which passes through the product, is reflected back into the mass of the product from the metallic conveyor belt, is sensed, and is tuned to cancel reflected microwave energy.

This apparatus consists of one or more microwave sources for illuminating the product, and one or more wave guide networks for guiding a microwave traveling wave from the microwave source to the product. It also includes one or more mode converters which convert rectangular wave guide mode to circular magnetic mode microwave energy. It also consists of a number of circular magnetic mode microwave applicators. It also consists of one or more metallic conveyor belts which act as microwave reflecting surfaces for reflecting the microwave traveling wave which is passed through a mass of product, and exited an opposite side directly back into the product. It also consists of one or more sensors of microwaves for measuring the microwave energy which is passed through the product after having exited the product and being reflected back into the product. These sensors report the energy measured to a computer tuning system. The apparatus also includes a computer tuning system which uses a reported microwave energy which is measured by the sensors, to calculate adjustments required to reduce the amount of reflected microwaves passing back toward the microwave source to approximately zero.

The apparatus also includes a means for tuning the microwaves generated based on a signal from the computer tuning system. The apparatus for generating heat in a product can be configured so that the microwave energy is applied normal to the longitudinal plane of the product or parallel to the transverse access of the product. The means of tuning the microwaves generated can be one or more capacitive probes which are activated by a signal from the computer tuning system.

Still another aspect of the invention is a method for generating heat in a product. The product is formed into a mass which has a center, a longitudinal and transverse axis. The method consists of illuminating the product which is conveyed through a processing cell by a conveying means, with a traveling wave of microwave energy from a microwave source which is conducted along a rectangular wave guide network as rectangular wave guide mode microwave energy, converting the microwave energy from the rectangular wave guide mode to circular magnetic mode using a mode converter; illuminating the product with a traveling wave of circular magnetic mode microwave energy; reflecting the traveling wave of microwave energy back into the product after it has passed through the product by use of a metallic conveyor belt which has been made reflective of microwave energy; sensing the reflected microwave energy which travels toward the source of microwave energy; using tuning probes to cancel the reflected microwave energy by induced reflections of an opposite phase in equal magnitude; passing the product through the microwave energy field in a continuous motion.

This method utilizes microwave sensors which are located in the wave guide. The microwave energy is tuned by inducing reflections by the use of tuning probes which equal and cancel the reflected microwave energy. Using circular magnetic mode microwaves can be the sole source of heat in a system, or it can be used in conjunction with supplemental heat which is applied to the product at various points of its processing.

The method and apparatus of the invention, using microwave energy which passes through the product, is reflected back into the product from one or more metallic conveyor belts, is sensed, and the microwave energy tuned to reduce the reflected microwave energy to approximately zero, thus optimizes the use of energy in heating a product. Since the microwave energy is applied by a number of microwave applicators normal to the longitudinal plane of the mass of product on a conveyor belt, a conveyor belt with product on it of any width can be accommodated. Since the energy is applied through a number of tuning systems which are being continually adjusted for optimal energy delivery as the product travels through the microwave heating apparatus, this apparatus accounts for variations in density, moisture content of the product, and other variables in the product to deliver a uniform distribution of heat to the product.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a prospective view of a prior art heating device for heating product by the application of hot air.

FIG. 2 is a perspective view of the heating system of the invention, with the side walls removed.

FIG. 3 is a side cross-sectional view of a sensing section of this invention.

FIG. 4 is a side cross-sectional view of a tuning probe of the invention.

FIG. 5 is a perspective cross-sectional view of a microwave source, wave guide, microwave applicator, and product in a processing cell of the invention.

FIG. 6 is a cross-sectional side view of the processing cell of the invention.

FIG. 7 is a perspective view of the microwave applicator showing its heat distribution pattern on a mass of product on a conveyor belt below the microwave applicator.

FIG. 8. is a top view of six microwave applicators showing the interaction of their heating tracks.

FIG. 9 is a schematic showing the tuning system of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

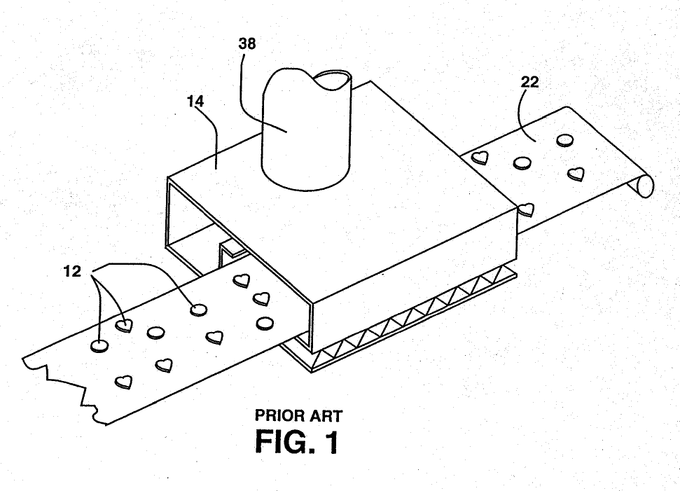

Referring to FIGS. 1 through 12, the invention is shown to advantage. FIG. 1 shows a simplified view of a prior art system for cooking or heating product such as foods on a conveyor belt. The product 12 is shown as a mass of small pieces of product, such as apple slices or vegetable pieces. However, the product 12 could be of any type of product, in any piece size, and the conveyor belt could be any number of different widths.

The product enters the heating machinery 14, which consists of a continuous metallic conveyor belt 22. The product 12 is carried through the heating machinery 14 on the metallic conveyor belt 22, and exits the heating machinery 14 after the product 12 has been sufficiently heated. While the product 12 is in the heating machinery 14, heat is applied from a heat source 38, and is directed onto or through the product 12. The heat can be in the form of steam, combustion gases from propane or natural gas burners, or hot air. The heat energy heats the product 12 and carries out the desired step of cooking, warming, blanching, or dehydrating.

In one type of prior art microwave heating system, a metallic conveyor belt is not a desirable nor a functional belt type. This is primarily due to the fact that most current systems use what are called “multi-mode” microwave cells or cavities. Multi-mode cavities are intentionally designed so that their physical dimensions are very large when compared to a single wavelength of the microwaves in use. The conveyor belt is usually suspended near the center of the microwave cavity in these multi-mode cavities.) This huge cavity will allow many systems of electric and magnetic fields to be set up inside. In order for a product to be heated by the microwaves, it is hoped that a belt that is NOT conductive, (instead it's transparent to microwaves), will allow the microwaves' electric fields to “hit” the process substrate from both above and below, increasing the chances of uniform or acceptable heating. A metal belt in this kind of heating system would “shield” the product in the microwave oven from being “hit” from underneath.

In the configuration of the present invention, the metallic belt is made to “look” just like a highly-polished mirror to the microwave energy. The reason that the metal belt reflects energy is because the electromagnetic microwave fields from the applicators will cause, (or induce), electric currents to flow in the metallic belt or image plane. These flowing currents are called “Image Currents”. These currents, (like all currents), will cause the generation of magnetic fields. (Currents causing magnetic fields can easily be seen in the experiment that we've all done in school science class where we take a flashlight battery or dry cell, and connect a wire between the (+) and (−) terminals causing a current to flow in the wire. This current then generates a magnetic field that we “see” when we hold this wire-connected-to-the-battery near a compass needle. The magnetic field surrounding the wire because of the current flowing through it will make the compass needle move around.

The Image Currents that are induced in the surface of the conducting metal belt are not direct currents, (DC), like in the battery example, but instead, are alternating or changing currents, (AC). Since these Image Currents are induced or caused by the microwaves from the applicators, the alternating “speed” of these induced Image Currents will be the same as the microwaves from the applicator use. Since these induced currents alternate or change in time, the resulting magnetic fields from these Image Currents on the metal belt surface will alternate as well. As described by Maxwell's Equations, and alternating, (changing), magnetic field will, in tern, produce an alternating or changing electric field. Electric fields are set up by distributions of electric charges or electric potential that are separated in space.

Also, since we know that these electric fields are changing in time, the space charge distribution that is causing the electric field must also be moving or changing in time. Since this electric field strength and direction is changing in time because of the changing charge distribution, the charges must be moving in time as well. Since moving charges ARE electric currents, a magnetic field is set up once again. The resulting alternating electric and magnetic, (electromagnetic), fields beginning with the time-varying Image Currents causing time-varying magnetic fields, which then generate time-varying electric fields, as described earlier, will launch themselves, (in a propagating system of electric and magnetic fields), straight up off the belt, (Image Plane), back toward the applicator. That is essentially the mechanism of microwave reflection from an image plane. The superposition of these two propagating systems of fields, the first from the applicator, and the second from the reflection off the Image Plane, which are traveling on opposite directions, will create an interference pattern of high electric and magnetic fields. This interference pattern does not move. Instead, it stands still, (these are called “standing waves”).

It turns out that there will be high magnetic field strength just next to the Image Plane because of the high Image Currents that are flowing in the Plane, and about one quarter wavelength up toward the applicator from the surface of the Image Plane, the electric field strength will be maximum. (That is the way the vector mathematics describing these two systems of fields will work.) Since most of the microwave heating that we do is done by the electric fields and not the magnetic fields, if we place the products that we wish to heat or process with microwaves at the physical position in the microwave cell where the electric field is highest, the process is optimum and is quite predictable and controllable.

The metallic conveyor belt 22 of the invention is grounded from leakage of microwave energy from the device by devices called “chokes” that will ground the belt, while not needed to actually touch the belt. This technique allows the belt to be moved or conveyed through the microwave power flux inside of the cell and not generate microwave leakage or sparks. Nearly any material that will support the conduction of Image Currents, (as described above), with stainless steel being the most often used material. Other metals materials would also work.

The metallic conveyor belt can form the bottom side of the processing cell, if the cell is designed to block the leakage of microwave energy. The system can also be designed so that one portion of the belt is in the processing cell, and the other portion is outside the processing cell.

The dimensions of a typical or preferred processing cell would vary depending on the requirements of the process. Minimum distances would be at least ½ wavelength cell height at the microwave frequency, and one wavelength wide and long. This is to allow the microwave fields to configure themselves in such a manner so as to allow the proper electric or magnetic field placement, (and hence, product placement), in the standing wave pattern between the metal belt or Image Plane and the applicators.

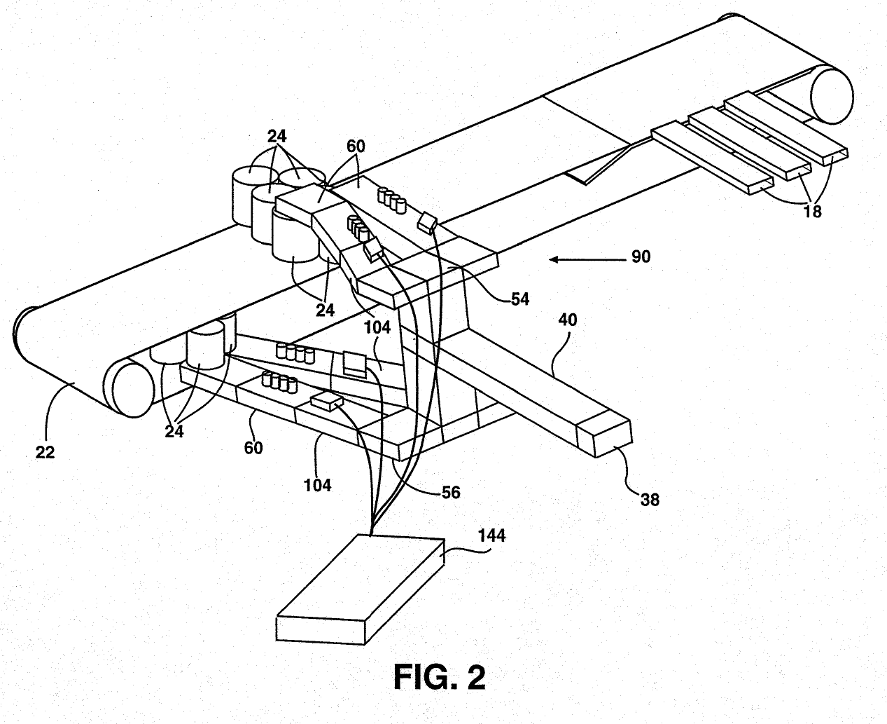

FIG. 2 shows a simplified view of the invention. The system for heating product includes a microwave source 38, wave guide straight sections 40, wave guide elbows 56, and wave guide tees 54. These wave guide components can be of any conductive material, but will typically be of aluminum. These comprise a wave guide network 90 which utilizes conventional technology components to carry microwave energy in the form of rectangular waveguide mode microwave energy from the microwave source 38 to applicators 24. Each wave guide source 38 supplies energy through a wave guide network 90 to a pair of applicators 24 above the processing cell 34 and a pair of applicators below the processing cell 34. Thus, three microwave sources 38 would be required to energize 12 applicators 24. Other configurations of microwave sources 38 to applicators 24 are of course possible while practicing the invention.

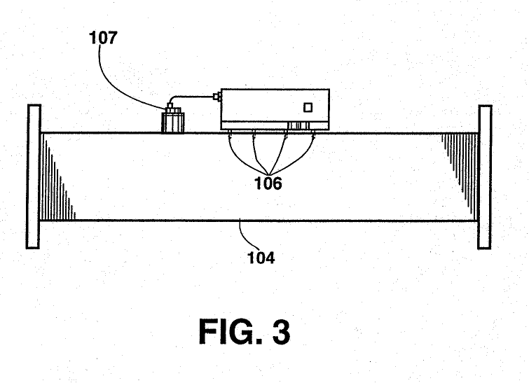

Incorporated into the wave guide network 90 is a sensor section 104 and a signal directional sensor 107. Each sensor section 104 contains four microwave sensors 106, as shown in FIG. 3. These are conventional technology sensors. They generate a signal which is routed to a computer 108, which in the best mode of the invention is mounted on sensor section 104. The sensors 106 are placed in the sensor section 104 such that the reflection phase displacement along the wave guide is 90 degrees in reflection.

Signal direction sensor 107 is described in U.S. Pat. No. 5,756,975, which is incorporated herein by reference.

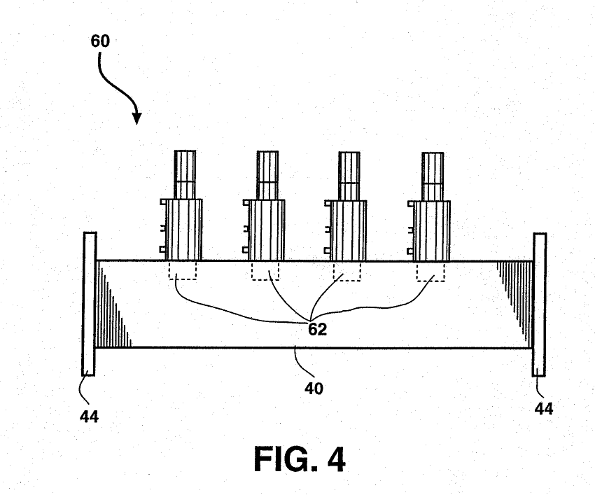

Mounted on the opposite side of the sensor section 104 from the microwave source 38 is a tuner section 60. Tuner section 60 includes four field divergent capacitive probes 62, which will be hereinafter referred to as tuning probes 62, which are spaced 8.06 inches apart. FIG. 4 shows tuning section 60 and tuning probes 62. In one preferred embodiment, tuning section 60 is 54 inches long. Tuning probes 62 extend 0-3 inches into tuning section 60. Tuning probes 62 are made of silver plated brass.

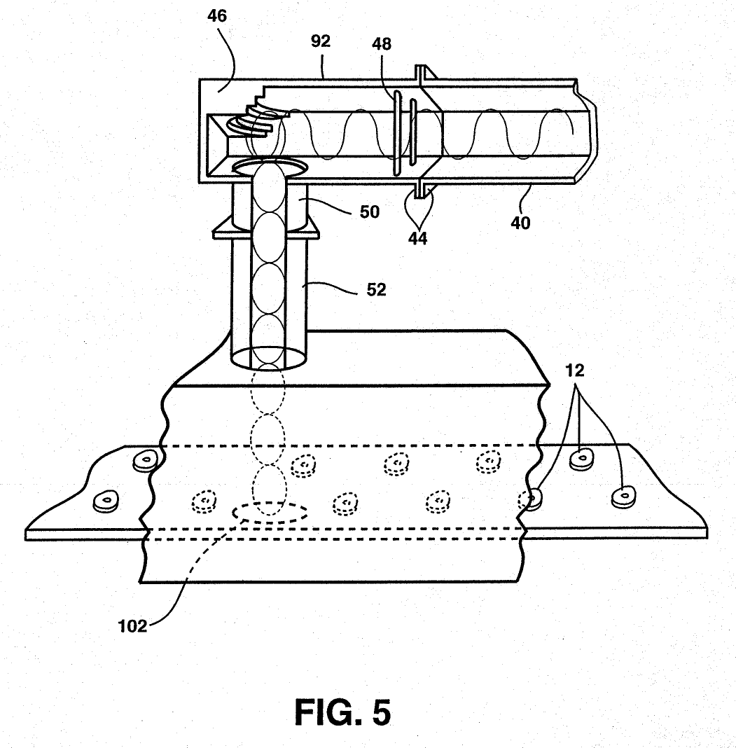

After the tuning section 60, the wave guide straight sections 40 attach by flanges 44 to a mode converter section 92. The interior detail of mode converter section 92 is shown in FIG. 5. Within the mode converter section 92 are located compensating structures 48, which are cylindrical structures typically of aluminum, though other conductive material is also suitable. Also within mode converter section 92 is located circular magnetic mode converter 46, which will be referred to as mode converter 46. Mode converter 46 is a three stepped structure, with each step having a curved surface. In one preferred embodiment, the mode converter 46 is 9.75 inches wide, and 4.88 inches tall. Each step is 1.62 inches in height, with a 5.5 inch radius to the curve. Directly below mode converter 46 and attached to mode converter section 92 is an output section 50. This in turn is attached to circular section field formation tube 52. In this preferred embodiment, circular section field formation tube 52 is 40 inches tall and like output section 50, is 11 inches in diameter. Circular section field formation tube 52 is in turn attached to processing cell 34. In one preferred embodiment, at the interface of circular section field formation tube 52 and heating section 34 is a Teflon® window 58. Each circular section field formation tube when joined to an output section 50 comprises an applicator 24.

Processing cell 34, shown in FIG. 5, is a generally rectangular chamber through which the product 12 passes.

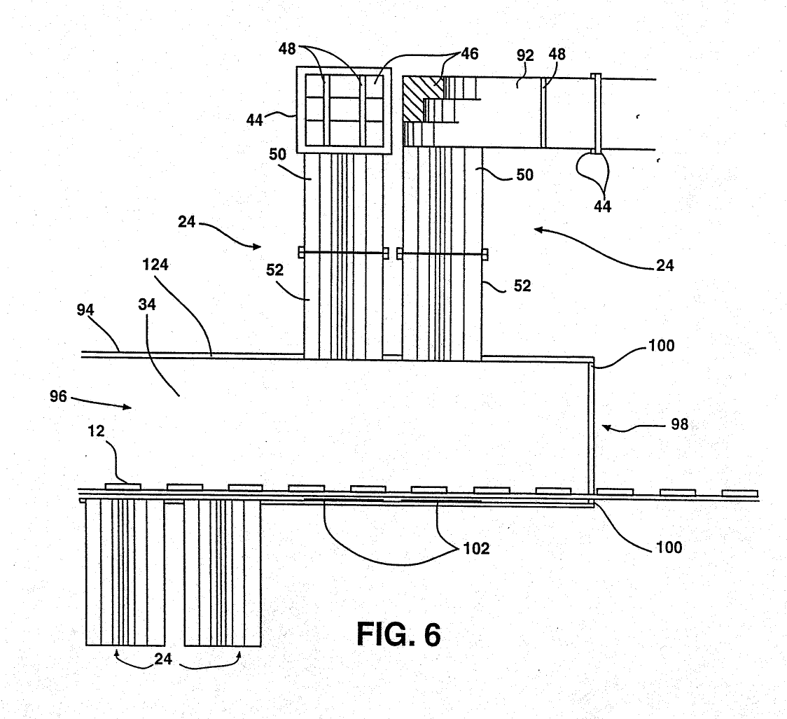

Processing cell 34 may optionally be surrounded by a water tank 94 shown in FIG. 6, which serves as an absorber of microwave energy which is scattered from the processing cell 34. Water tank 94 is filled with a water solution which is routed to a radiator (not shown). Processing cell 34 has a first aperture 96 through which product 12 enters the processing cell 34. Processing cell 34 also has a second aperture 98 through which product 12 exits the processing cell. Surrounding the first and second apertures 96 and 98 are three quarter wave guide wavelength wave traps 100. These are generally rectangular sections which are open on the side facing the product 12, but which are closed on all other sides. Each wave trap 100 is short circuited at a distance equaling three quarter wave guide wavelength from the open end.

The metallic conveyor belt 22 forms a reflective surface 102 under the product to be heated.

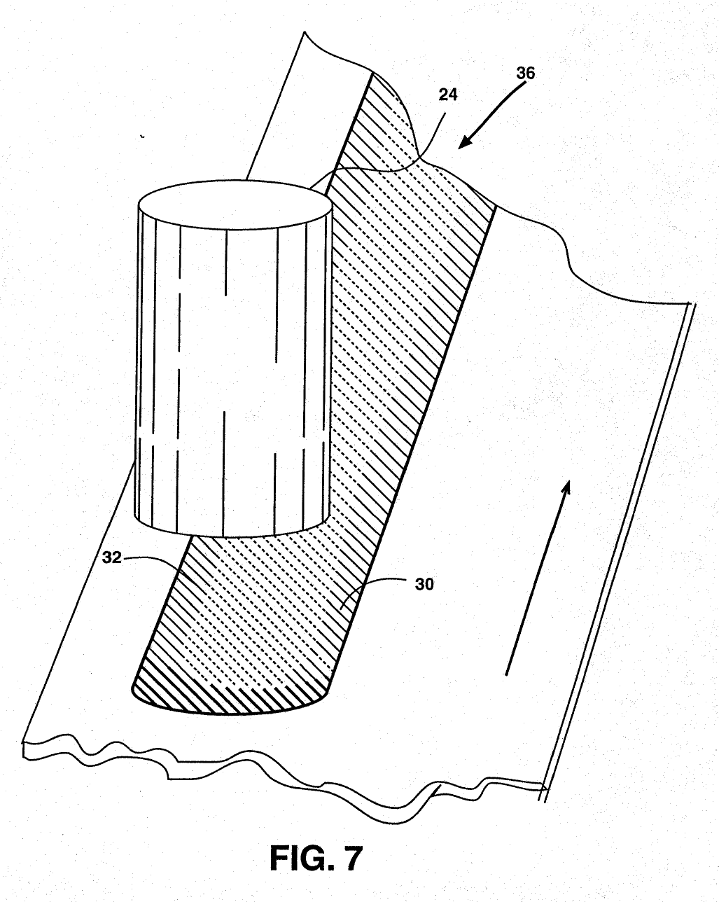

In operation, a product 12 is placed on a moving metallic conveyor belt 22 which moves the product 12 into the processing cell. The continuous metallic conveyor belt 22 is reflective of microwave energy, as explained above. As the product 12 passes in a continuous motion through processing cell 34, microwave energy is directed through the product 12 from above and below, as shown in FIG. 3. This microwave energy originates from a number of microwave sources 38, preferably one microwave source for each four applicators 24. The microwave energy passes through a wave guide network 90, through sensor section 104 and through tuner section 60, and reaches mode converter section 92, shown in further detail in FIG. 7. Within mode converter section 92, the microwave energy encounters mode converter 46, which converts the microwave energy from rectangular waveguide mode (TE₁₀) to circular magnetic mode (TM₀₁) microwave energy. Although the preferred embodiment utilizes circular magnetic mode energy to heat the product 12, other modes of microwave energy are possible for use by this system. These other modes could include an evanescent field. Inherent in the encounter of microwave energy with mode converter 46, reflections of microwave energy occur, and these reflections travel back toward the microwave source 38. These are canceled out by equal and opposite wave patterns set up in the microwave path by compensating structures 48.

After exiting the mode converter section 92, the microwave energy travels through the output section 50 and into the circular section field formation tube 52. The output section 50 acts as a Fresnel field suppression section. This section allows the Fresnel fields that are high in strength in the direct vicinity of the mode converter 46 to fall off as the microwaves, now in the new symmetrical circular magnetic mode, travel toward the processing cell 34. As it exits the circular section field formation tube 52, the microwave energy enters the processing cell 34 in a circular magnetic mode. In this mode, the microwave energy enters the processing cell 34 and the product 12 within the processing cell 34 as an incident wave with two separate electric field components that are oscillating at the operating microwave frequency. This exposes the product 12 to electric fields in two axes, one axial, or along the axis of travel of the incoming microwave signal, and one radial, from the center of the applicator 24.

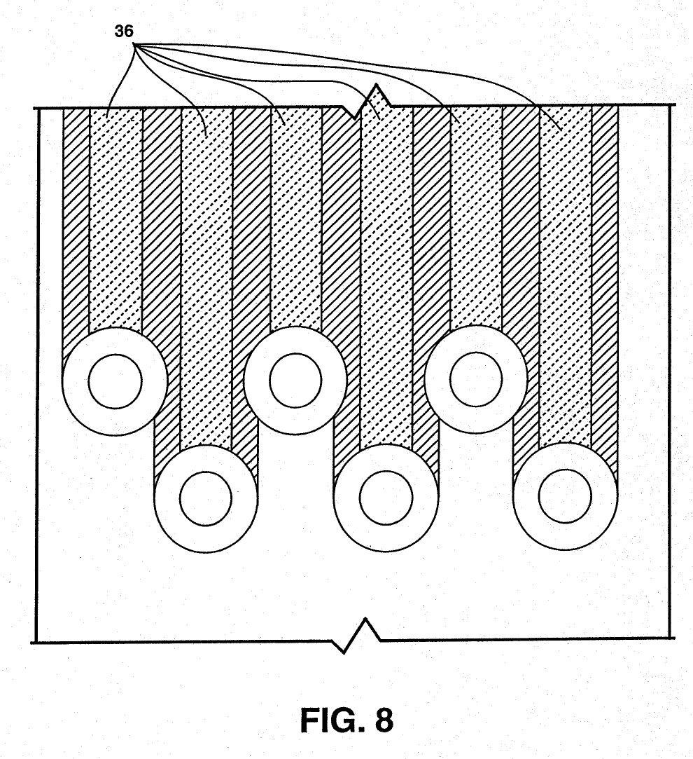

This system exposes the product 12 to a system of fields that are highly efficient in converting the energy of the microwaves into heat, which is produced in the product. Further, since this microwave energy is directed normal to the longitudinal axis of the product 12, the width of a product 12 and the metallic conveyor belt 22 is not limited by the limits of penetration of microwave energy from the side of the product. FIG. 6 shows the arrangement of banks of applicators 24 above and below the product 12 and the metallic conveyor belt 22. The applicators 24 positioned above the product 12 in FIG. 6 show a cross section and an end view of the mode converter section 92. FIG. 7 shows the heating track 36 which results from a product 12 moving through the outer heating zone 30 and the inner heating zone 32 which is projected onto the metallic conveyor belt 22 from applicator 24. Any number of sizes and configurations of product are equally well suited for use with this system. FIG. 8 shows the heating tracks 36 on product 12 and metallic conveyor belt 22 which result from a bank of six applicators 24. In one preferred mode, the applicators 24 are spaced with their center point 8.57 inches apart, with a first group of three applicators 24 set with centers 15 inches from the centers of another group of three. The first group of three applicators 24 are spaced with their centers 7½ inches from the end of the processing cell 34, which itself is 60 inches wide. A similar bank would be positioned on the opposite side of the product. In the best mode of the invention, the maximum width of a product 12 would be slightly narrower than the outside edges of the outside applicators 24. Although a bank of six applicators is shown, there is no limitation on the number of applicators which could be used. To heat a wider mass of product 12, banks of 8, 10 or more applicators are possible.

As the incident microwave energy from the applicator 24 passes through the product 12, some is absorbed in the product 12 and some passes through the product 12. The microwave energy which passes through the product 12 strikes the reflecting surface 102 of the metallic conveyor belt 22, positioned below and supporting the product 12. The reflecting surface 102 of the metallic conveyor belt 22 reflects the incident microwave energy directly back into the product 12 as a reflected wave, where it again passes through the product. The incident and reflected waves form a standing wave located within the product 12, and heat the water within the product. The superposition of the incident and reflected waves results in an interference pattern of standing waves that are positioned in between the applicator 24 and the reflecting surface 102 of the metallic conveyor belt 22. This pattern of standing waves will result in increased electric field strength inside the product 12 assembly due to the electric field vectors, one incident from the applicator 24 and the other launched from the reflecting surface 102, adding constructively. Maximum loss, and hence, best microwave match to the product 12 assembly will occur when maximum electric field is present where the high microwave losses are, which is at the center of the product 12.

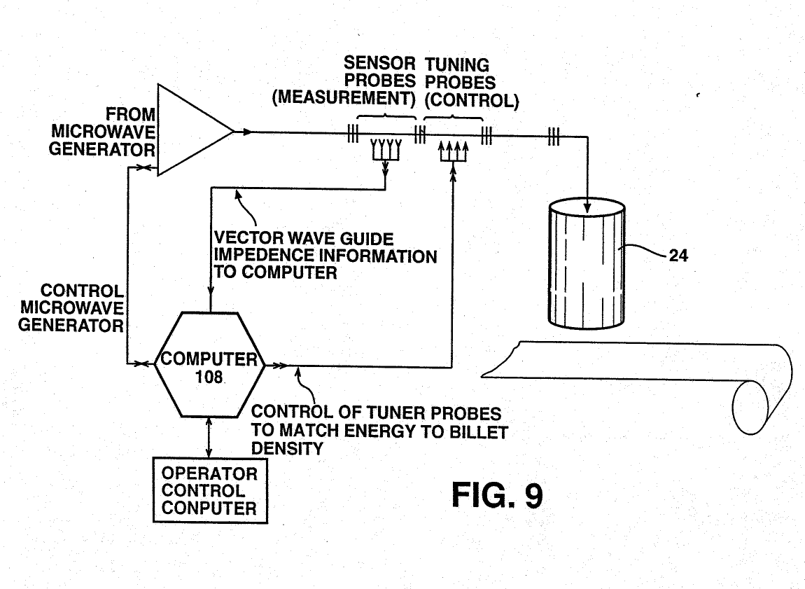

As the incident microwave energy exits the applicator 24, is passes through a number of surfaces which cause reflections. The first is a plane encountered when the microwave energy enters the processing cell 34. The next reflection surface is the first layer of the product 12, whatever shape that might be. Each subsequent layer of product surface causes further reflections, and each reflection wave itself results in smaller reflections as they pass through the product. Since each of these reflected waves has an associated magnitude and phase, which is the microwave equivalent of strength and direction, the reflections combine vectorally and either add to each other or cancel each other out. The summed reflection wave from all the reflection surfaces, including the reflected wave which resulted from the incident wave passing through the product and being reflected from the reflecting surface of the metallic conveyor belt 22, travels back through the applicator 24, through the mode converter section 92, and through the tuning section 60 and into the sensor section 104 in a direction opposite to that of the incident wave. This summed reflected wave is sensed and tuned as shown in schematic in FIG. 9. Since each applicator 24 has its own sensing section 104 and tuning section 60, each applicator can be individually and independently tuned to adjust to changes in reflections caused by changing density of product under a particular applicator.

In the sensor section 104 the sensor probes 106 detect the phase and magnitude of reflected microwave radiation reaching the sensor section 104. The sensor probes 106 are placed in the sensor section 104 such that the reflection phase displacement along the wave guide is 90 degrees in reflection. These sensors provide complete vector representation. The sensor probes 106 are spaced exactly one-eighth wave guide wavelength at the operating frequency of the system. Information from all four sensor probes 106 is sent to computer 108. The computer 108 uses input from the four sensor probes 106 to determine the vector reflection coefficient.

Based on this information calculated individually for each applicator 24, the computer 108 calculates the needed phase and magnitude needed to completely counteract the reflected energy, and sends a signal to the tuner probes to extend into or retract from the tuning sections 60. As the tuning probe 62 is extended into the tuning section 60, it introduces capacitive discontinuities, which could also be called an induced reflection. Since the tuning probes 62 are also spaced at 90 degrees phase displacement at the center operating frequency, their adjustment can result in setting up a standing wave pattern that will result in an induced reflection which will sum with all the other reflections and cancel them out. The induced microwave reflection is opposite in phase and equal in magnitude to the reflected microwaves. In this way the reflected energy is eliminated, and all the energy of the microwave is utilized to heat the product 12. Due to real time adjustments of the induced reflection, irregularities in the density of the product, its water content, and its composition are compensated for, and uniform and efficient heating is achieved and maintained. This allows for uniform heating throughout the product and heating to the precise temperature desired.

An additional benefit in the use of the sensing system is the option of its use as a quality monitor. Any sudden change in sensed data would alert the operator to a condition which should be investigated. A computer 144 is provided for this purpose. Computer 144 connects to each computer 108 on each sensing section 104 by optic fiber cable.

Between the microwave source 38 and the sensors 106 is located a signal direction sensor 107, which is shown in FIG. 13. This device is built to sense microwave power levels coming from one direction only, and senses the power level coming from the microwave source 38. The loop 132 of the signal direction sensor 107 senses both electric and magnetic waves from the microwave signals in the waveguide. These signals combine as vectors at both ends of the loop. The vectors are equal in magnitude and opposite in direction at one end of the loop, and equal in magnitude and equal in direction at the other, depending on the direction of travel of the microwaves in the waveguide that the sensor is connected to. The signals that are in the unwanted direction, from the processing cell 34, are diverted. The signals that are in the desired direction, from the microwave source 38, are sensed and reported to the computer. The computer uses the sensed power level of the microwave source 38 as one piece of information to use in calculating the tuning signals which are required for the tuning probes 62. Since the signal direction sensor 107 is sensitive to the flow of microwave energy in one direction only, it is not affected by the interference pattern of standing waves created by the superposition of the two waves traveling in opposite directions.

Some of the microwave energy which enters the processing cell 34 is reflected away from the product. Three mechanisms are in place to prevent the escape of any of these reflected microwaves. As shown FIG. 6, the processing cell 34 is surrounded by a water tank 94. The walls of the water tank 94 are of a material which is transparent to microwave energy, such as high density polyethylene. The fluid 124 in water tank 94 is an aqueous solution preferably containing propylene or ethylene glycol. The fluid 124 in the water tank 94 is routed to a conventional radiator (not shown), to dissipate any heat which is generated in the fluid 124.

In addition to the water tank 94 filled with fluid 124 surrounding processing cell 34, around the first aperture 96 to the processing cell and the second aperture 98 to the processing cell are located three-quarter wave guide wavelength traps 100. These are also shown in FIG. 6. These wave guide traps are provided to allow the electric fields in the trapped sections to fully form, so that an appropriate field profile from the trap is presented to the processing cell 34 fields so as to stop the electric fields from exiting the processing cell 34. By these three devices: the water tank 94, and the wave traps 100 at either end of the processing cell 34, escape of unwanted amounts of microwave energy from the device is prevented.

The product 12 is heated in the processing cell 34 to the temperature desired. This can be a different temperature, such as if the purpose of the process is to cook the food, blanch the food, or dehydrate the food. In the case of dehydration, supplemental air may be passed through or around the product 12 to carry away moisture and assist in the dehydration of the product 12.

In accordance with the best mode contemplated for the application of this invention, assemblies of product are heated using microwave energy in a continuous stream.

The system can be used to blanch vegetables such as carrots, corn, green beans, and potatoes, and other vegetables. It can also be used to dehydrate products such as sliced apples, diced apples, carrot pieces, green beans, corn, potatoes, and other fruits and vegetables. The device can also be used to cook dough or breaded foods, pizza, meats, soups and stews, or other kinds of cooked foods. Although a nominal width of 4 feet is anticipated, it is planned that the apparatus and method will accommodate metallic conveyor belts 8 feet in width or larger. The width of the product is determined by the width of the metallic conveyor belt 22, and is not anticipated to be a limitation of this system.

A microwave energy source for this invention is a conventional microwave power source. The power output is nominally 75 kWh for each transmitter used by the system. The current design of the system calls for three microwave sources 38 and twelve applicators 24 to be utilized.

In the following description and in the figures, like elements are identified with like reference numerals. The use of “or” indicates a non-exclusive alternative without limitation unless otherwise noted. The use of “including” means “including, but not limited to,” unless otherwise noted.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. Hence, the foregoing description should not be construed to limit the scope of the invention, which is defined in the following claims.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A microwave heating system for heating a product, comprising:
one or more microwave applicators which direct microwave energy into a processing cell:
a metallic conveyor belt which moves through said processing cell, and which is reflective of microwave energy, with the metallic conveyer belt configured to support said product to be heated by microwave energy;
in which said microwave energy passes through said product, is reflected off said metallic belt, and is redirected through said product, causing heating of said product.

2. The microwave heating system of claim 1 in which said one or more microwave generators are configured to direct microwave energy at said metallic conveyor belt so that said microwave energy strikes said conveyor belt and said product approximately normal to the belt.

3. The microwave heating system of claim 1 in which said processing cell is bounded by a microwave reflective left side, right side, top, bottom, and a first end wall and a second end wall, with said end walls each further comprising a belt passage.

4. The microwave heating system of claim 3 in which said end walls further comprise a microwave choke, for allowing passage of said belt, but blocking the passage of microwave energy from said processing cell.

5. The microwave heating system of claim 1 in which said conveyor belt is made of a continuous single pliable long sheet of metal.

6. The microwave heating system of claim 5 in which said belt is made of stainless steel.

7. The microwave heating system of claim 1 in which said belt is made of mesh metal material.

8. The microwave heating system of claim 1 in which said top section of belt goes through processing cell, bottom section of belt goes under the bottom side of the processing cell.

9. The microwave heating system of claim 1 in which said microwave applicators are used in any applicable waveguide mode in the cell.

10. The microwave heating system of claim 4 in which said microwave applicators are in a side by side array in one or more rows.

11. The microwave heating system of claim 1 in which said applicators include adjustment for focusing microwave fields for optimal heating in said product.

12. The microwave heating system of claim 10 in which said adjustment system includes the mechanical and electrical distance of the belt top surface below the applicator insertion planes.

13. The microwave heating system of claim 3 in which said metallic conveyer belt forms the bottom side of the processing cell.

14. A method for generating heat in a product, in which the method comprises:
conveying product on a metallic conveyor belt into a microwave field for heating;
generating microwave energy from a microwave source;
conducting the microwave energy through a wave guide network to a processing cell;
illuminating the product with microwave energy;
reflecting the microwave energy from a top surface of said metallic conveyor belt back into the product after it has passed through the product;
sensing the reflected microwave energy which travels toward the source of the microwave energy;
tuning the microwave energy so that the reflected microwave energy is canceled by induced reflections of an opposite and equal nature; and
passing the product to be heated through the microwave energy field in a continuous motion.

15. The method of claim 14 in which sensing is accomplished by a plurality of sensors located in the wave guide network.

16. The method of claim 14 in which tuning is accomplished by using probes which induce microwave reflections which equal and cancel the reflected microwave energy from the processing cell.

17. The method of claim 14 in which illuminating the product with the microwave energy is done in a preheating stage by applying microwave energy which is in a form other than rectangular waveguide mode, such as evanescent field.

18. The method of claim 14 which further comprises displaying process parameters using a computer.

19. A method for generating heat in a product, in which the method comprises:
conveying product on a metallic conveyor belt into a microwave field for heating;
generating microwave energy from a microwave source;
conducting the microwave energy through a rectangular microwave wave guide network as rectangular waveguide mode microwave energy;
converting the microwave energy from rectangular waveguide mode to circular magnetic mode using a mode converter;
illuminating the product with a traveling wave of circular magnetic mode microwave energy;
reflecting the traveling wave of microwave energy back into the product after it has passed through the product;
sensing the reflected microwave energy which travels toward the source of the microwave energy;
tuning the microwave energy so that the reflected microwave energy is canceled by induced reflections of an opposite and equal nature; and
passing the product through the microwave energy field in a continuous motion.
